(19) United States
(12) Patent Application Publication
(10) Pub. No.: US 2015/0042686 A1
(43) Pub. Date: Feb. 12, 2015

(54) Method Applied to a Display for Displaying a Sub-frame

(71) Applicant: Fido Chang, New Taipei (TW)

(72) Inventor: Fido Chang, New Taipei (TW)

(21) Appl. No.: 13/964,254

(22) Filed: Aug. 12, 2013

(51) Int. Cl. G06T 3/40

(52) U.S. Cl. CPC G06T 3/40
USPC 345/660

(57) ABSTRACT

A method applied to a display for displaying a sub-frame, which includes calculating a horizontal proportion and a vertical proportion of a first sub-frame window to a first input sub-frame. When the horizontal proportion is greater than the vertical proportion, the first input sub-frame is horizontally and vertically scaled by the vertical proportion for generating a second input sub-frame. Horizontal dimension of the first sub-frame window is adjusted to be the same as the second input sub-frame for generating a second sub-frame window, so as to display the second input sub-frame. When the horizontal proportion is smaller than the vertical proportion, the first input sub-frame is horizontally and vertically scaled by the horizontal proportion for generating the second input sub-frame. Vertical dimension of the first sub-frame window is adjusted to be the same as the second input sub-frame for generating the second sub-frame window, so as to display the second input sub-frame.

### BACKGROUND OF THE INVENTION

1. Field of the Invention

The present invention relates to a method applied to a display for displaying a sub-frame, and more particularly, to a method applied to a display capable of adjusting dimensions of a sub-frame so as to display the adjusted sub-frame.

2. Description of the Prior Art

A conventional display has the function to display at least two frames on the same screen, which is named as picture-in-picture (PIP) function. Referring to FIG. 1, FIG. 1 is a diagram of the conventional display with the PIP function in the prior art. In this embodiment, the display is electrically connected to two signal sources. The signal sources may be the wireless (or wire) broadcast signal received by the tuner, or the video signal from the video player, digital versatile disc (DVD) player or personal computer (PC). The display scales an input frame 21 provided from one of the signal sources to generate an output frame 31, and displays the output frame 31 on the screen 11. The display shows the input frame 21 over the screen 11 in a full screen manner. In addition, the display further scales an input frame 22 provided by the other signal source to generate an output frame 32, and displays the output frame 32 on a small inserted window 12 located on a corner of the screen 11, which means the input frame 22 is displayed on the inserted window 12 in a full window manner, so as to implement the PIP function. For distinction and convenience of explanation, the input frame 21 and the output frame 31 are respectively named as the input main frame and the output main frame, the input frame 22 and the output frame 32 are respectively named as the input sub-frame and the output sub-frame, and the inserted window 12 is named the sub-frame window.

In the conventional PIP function, when an aspect ratio of the sub-frame window is different from an aspect ratio of the input sub-frame, the input sub-frame displayed on the sub-frame window in the full window manner (or the output sub-frame displayed on the sub-frame window) is deformed. Referring to FIG. 2, FIG. 2 is a diagram of an image deformed on the sub-frame window in the prior art. In the embodiment, the sub-frame window 12 has 640×360 pixels, and the input sub-frame 22′ has 800×600 pixels, so that the aspect ratio of the sub-frame window 12 is 16:9 (≈1.78:1), and the aspect ratio of the input sub-frame is 4:3 (≈1.33:1). Therefore, the aspect ratio of the sub-frame window 12 is different from the aspect ratio of the input sub-frame 22′. The input sub-frame 22′ has to be horizontally scaled by a horizontal proportion (0.8=640/800) and vertically scaled by a vertical proportion (0.6=360/600) to generate the output sub-frame 32′ that has 640×360 pixels and can be displayed on the sub-frame window 12 (which also has 640×360 pixels). However, the output sub-frame 32′ is deformed because the horizontal proportion and the vertical proportion are unmatched between the output sub-frame 32′ and the input sub-frame 22′. The horizontal proportion is greater than the vertical proportion, so that the output sub-frame 32′ is stretched at the horizontal direction. For example, a circular form on the input sub-frame 22′ is deformed as an ellipse form on the input sub-frame 32′. The conventional display may include functions to adjust dimensions of the sub-frame window, however, the conventional display only provides several fixed sub-frame windows (such as a small window, a median window and a large window) to be selected. When the aspect ratio of the sub-frame window is different from the aspect ratio of the input sub-frame, the input sub-frame displayed on the sub-frame window in the full window manner is deformed yet.

When the aspect ratio of the sub-frame window is different from the aspect ratio of the input sub-frame, the aspect ratio of the output sub-frame has to be the same as the aspect ratio of the input sub-frame to prevent the output sub-frame displayed on the sub-frame window from deformation; however, there are black bars occurred on the sub-frame window. Referring to FIG. 3, FIG. 3 is a diagram of the sub-frame window with the black bars in the prior art. In the embodiment, the sub-frame window 12 has 640×360 pixels, the input sub-frame 22′ has 800×600 pixels, so that the aspect ratio (16:9≈1.78:1) of the sub-frame window 12 is different form the aspect ratio (4:3≈1.33:1) of input sub-frame 22′. For keeping the same aspect ratio of the output sub-frame and the input sub-frame, the input sub-frame 22′ has to be horizontally and vertically scaled by matched horizontal and vertical proportions, respectively; that is, horizontally scaled by the horizontal proportion (0.6=360/600) and vertically scaled by the vertical proportion (0.6=360/600), so as to generate the output sub-frame 32″ that has 480×360 pixels. Because the sub-frame window 12 (which has 640×360 pixels) is greater than the output sub-frame 32″ (which has 480×360 pixels), the sub-frame window 12 may shows the output sub-frame 32″ and two black bars located on the left and right sides of the output sub-frame 32″. The output main frame 31 displayed on the screen 11 showing the sub-frame window 12 with the black bars is inartistic, and therefore, the conventional PIP function utilizes the method illustrated in FIG. 2 to prevent the black bars. However, the method illustrated in FIG. 2 cannot prevent the deformation.

### SUMMARY OF THE INVENTION

The present invention provides a method applied to a display for displaying a sub-frame for solving above drawbacks of the deformation and the black bars.

According to the claimed invention, the method applied to the display for displaying the sub-frame is disclosed. The method includes calculating a horizontal proportion and a vertical proportion of a first sub-frame window to a first input sub-frame when the display determines that an aspect ratio of the first sub-frame window is different from an aspect ratio of the first input sub-frame. When the horizontal proportion is greater than the vertical proportion, the first input sub-frame is horizontally scaled by the vertical proportion and vertically scaled by the vertical proportion for generating a second input sub-frame. Horizontal dimension of the first sub-frame window is adjusted to be the same as the second input sub-frame for generating a second sub-frame window, and the second input sub-frame is displayed on the second sub-frame window. When the horizontal proportion is smaller than the vertical proportion, the first input sub-frame is horizontally scaled by the vertical proportion and vertically scaled by the vertical proportion for generating the second input sub-frame. Horizontal dimension of the first sub-frame window is adjusted to be the same as the second input sub-frame for generating the second sub-frame window, and the second input sub-frame is displayed on the second sub-frame window.

According to the claimed invention, the method further includes displaying the first input sub-frame on the first sub-frame window in a full window manner when the display determines that the aspect ratio of the first sub-frame window is identical with the aspect ratio of the first input sub-frame.

According to the claimed invention, the method further includes moving the second sub-frame window to an edge of a screen of the display.

According to the claimed invention, the method is applied to the display with picture-in-picture function.

The present invention can dynamically adjust dimensions of the first sub-frame window according to the aspect ratio of the first input sub-frame, so that the first input sub-frame displayed on the adjusted second sub-frame window in the full window manner does not have drawbacks of the deformation and the black bars.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the conventional display with the PIP function in the prior art.

FIG. 2 is a diagram of an image deformed on the sub-frame window in the prior art.

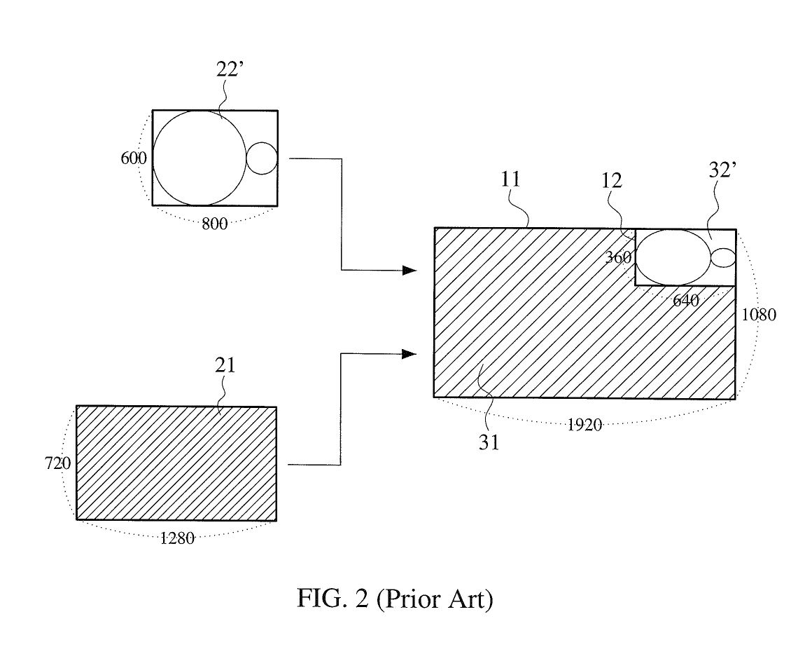

FIG. 3 is a diagram of the sub-frame window with the black bars in the prior art.

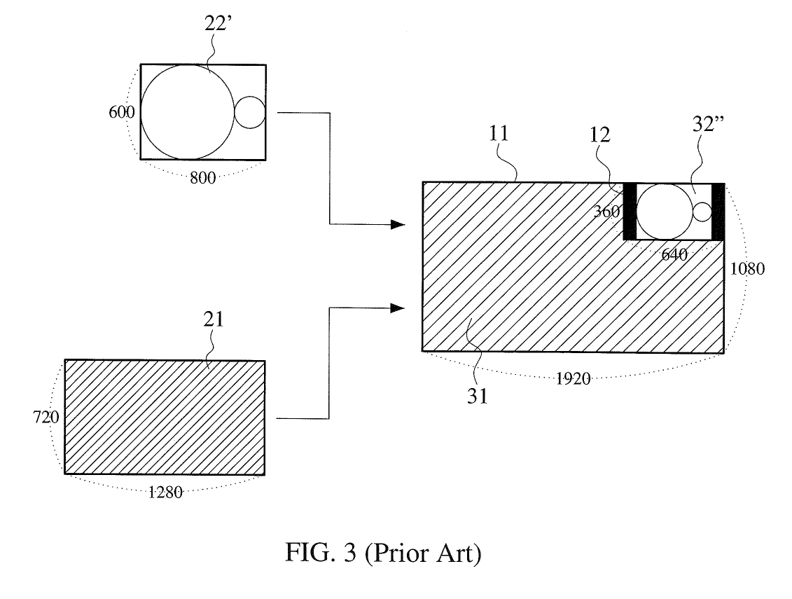

FIG. 4 is a flow chart of a method applied to a display for displaying a sub-frame according to an embodiment of the present invention.

FIG. 5 is a diagram of the aspect ratio of the first sub-frame window being greater than the aspect ratio of the first input sub-frame according to the embodiment of the present invention.

FIG. 6 is a diagram of the aspect ratio of the first sub-frame window being smaller than the aspect ratio of the first input sub-frame according to the embodiment of the present invention.

### DETAILED DESCRIPTION

As following description, elements having the same numeral reference have the same functions and structures in different embodiments of the present invention.

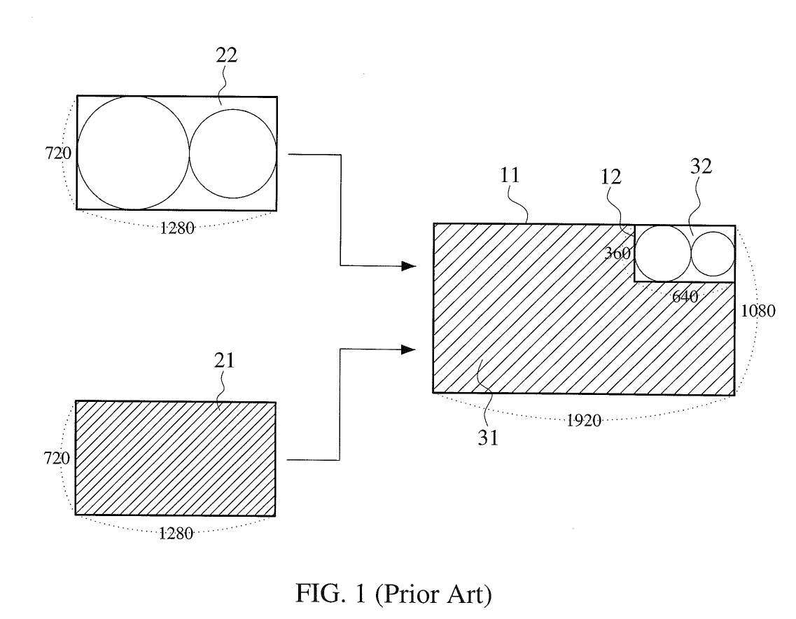

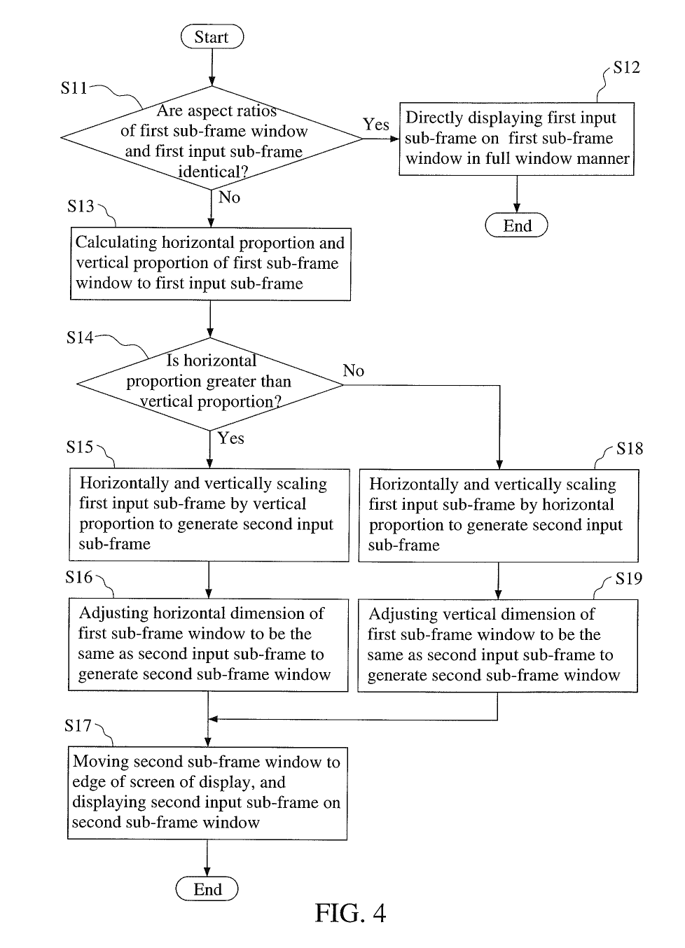

Referring to FIG. 4, FIG. 4 is a flow chart of a method applied to a display for displaying a sub-frame according to an embodiment of the present invention. In this embodiment, the display is electrically connected to two signal sources. The display scales an input main frame from one of the signal sources and displays the input main frame on its screen in a full screen manner. The display further scales an input sub-frame (the first input sub-frame) from the other signal source and then displays on a sub-frame window (the first sub-frame window) on the screen in a full window manner, so as to implement PIP function. As shown in FIG. 4, the method applied to the display of the present invention utilizes the display to determine whether an aspect ratio of the first sub-frame window is identical with an aspect ratio of the first input sub-frame (step S11). The first sub-frame window, as shown in FIG. 1, has 640×360 pixels, and the first input sub-frame, as shown in FIG. 1, has 1280×720 pixels, so that the aspect ratios of the first sub-frame window and the first input sub-frame are both 16:9 (≈1.78:1). Thus, the display can directly display the first input sub-frame on the first sub-frame window in the full window manner (step S12). The first input sub-frame is horizontally scaled by the horizontal proportion (0.5=640/1280) and vertically scaled by the vertical proportion (0.5=360/720) to generate a sub-frame having 640×360 pixels, which can be displayed on the first sub-frame window that also has 640×360 pixels. The sub-frame displayed on the first sub-frame window does not have drawbacks of deformation and black bars because the horizontal proportion (0.5) and the vertical proportion (0.5) are the same or matched.

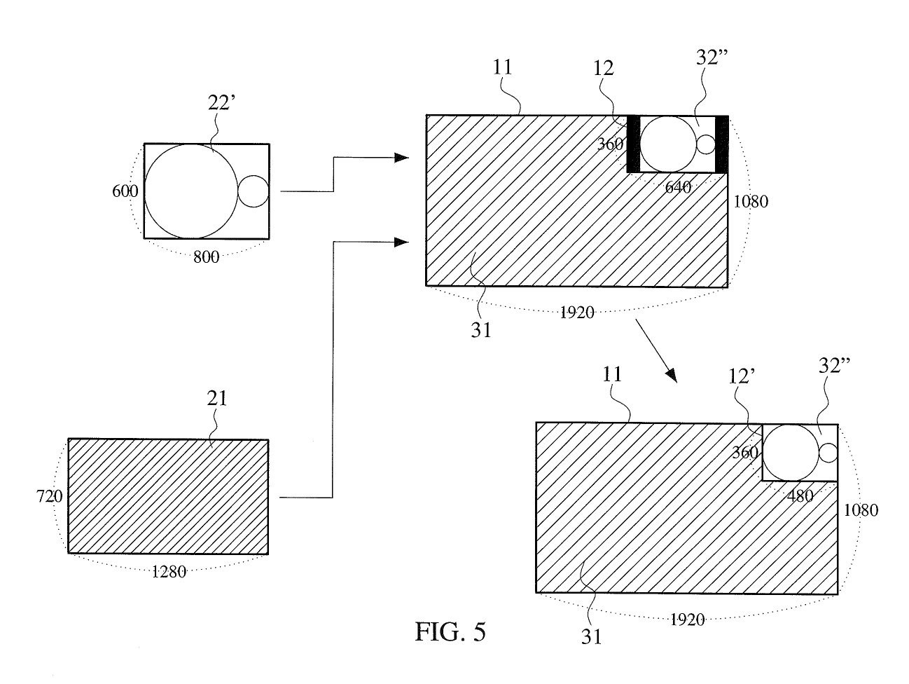

Referring to FIG. 4 and FIG. 5, FIG. 5 is a diagram of the aspect ratio of the first sub-frame window being greater than the aspect ratio of the first input sub-frame according to the embodiment of the present invention. As shown in FIG. 5, the first sub-frame window 12 has 640×360 pixels, and the first input sub-frame 22′ has 800×600 pixels, so that the aspect ratio of the first sub-frame window 12 is 16:9 (≈1.78:1), and the aspect ratio of the first input sub-frame 22′ is 4:3 (≈4.33:1). Therefore, when the display determines that the aspect ratio of the first sub-frame window 12 is different from the aspect ratio of the first input sub-frame 22′ by the step S11, the first input sub-frame 22′ has to be horizontally scaled by the horizontal proportion and vertically scaled by the vertical proportion which is the same as the horizontal proportion in order to prevent the image displayed on the first sub-frame window 12 from deformation, and the scaled image has to be fit with the horizontal or vertical dimension of the first sub-frame window 12. To do this, the display has to calculate the horizontal proportion and the vertical proportion of the first sub-frame window 12 to the first input sub-frame 22′ (step S13), to determine relation between the horizontal proportion and the vertical proportion (step S14), and to select the small one for next procedure.

In this embodiment, the horizontal proportion of the first sub-frame window 12 to the first input sub-frame 22′ is 0.8 (=640/800), the vertical proportion of the first sub-frame window 12 to the first input sub-frame 22′ is 0.6 (=360/600), and therefore, the horizontal proportion (0.8) is greater than the vertical proportion (0.6). The display selects the vertical proportion (0.6) to scale the first input sub-frame 22′ at the horizontal direction and the vertical direction to generate the second input sub-frame 32″ (step S15), which means the first input sub-frame 22′ is horizontally and vertically scaled by the vertical proportion (0.6) to generate the second input sub-frame 32″ that has 480×360 pixels. Meanwhile, the first sub-frame window 12 shows the second input sub-frame 32″ and the black bars located on the right and left sides of the second input sub-frame 32″ if the second input sub-frame 32″ is directly displayed on the first sub-frame window 12. Thus, the display does not directly display the second input sub-frame 32″ on the first sub-frame window 12. The display adjusts or reduces the horizontal dimension of the first sub-frame window 12 to be the same as the second input sub-frame 32″ to generate the second sub-frame window 12′ (step S16). Then, the second sub-frame window 12′ is moved to the edge of the screen 11, and the second input sub-frame 32″ displayed on the second sub-frame window 12′ does not have drawbacks of the deformation and the black bars.

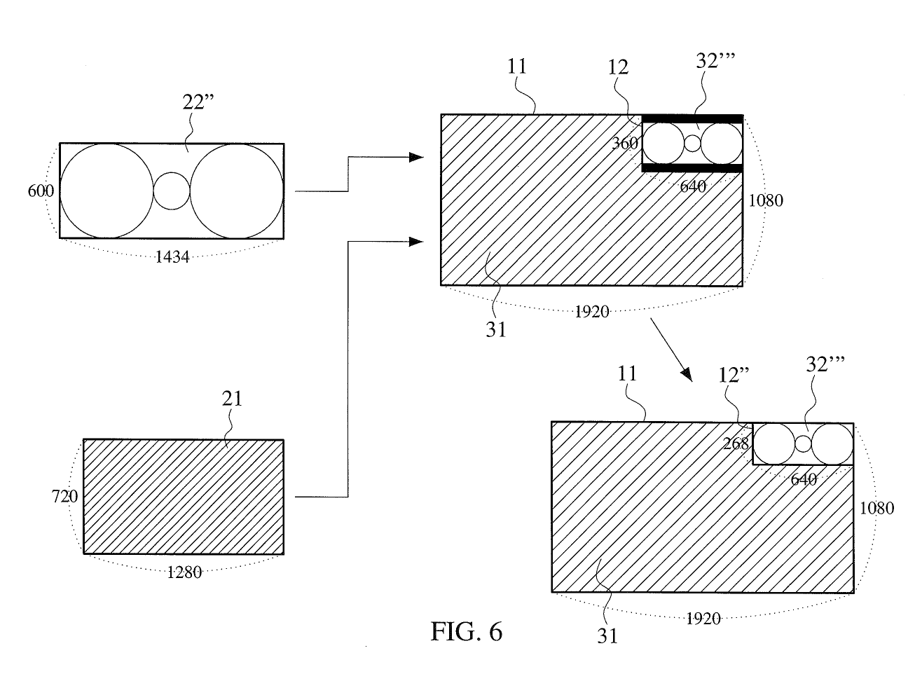

Referring to FIG. 4 and FIG. 6, FIG. 6 is a diagram of the aspect ratio of the first sub-frame window being smaller than the aspect ratio of the first input sub-frame according to the embodiment of the present invention. As shown in FIG. 6, the first sub-frame window 12 has 640×360 pixels, and the first input sub-frame 22″ has 1434×600 pixels, so that the aspect ratio of the first sub-frame window 12 is 16:9 (≈1.78:1), and the aspect ratio of the first input sub-frame 22″ is 2.39:1. Therefore, when the display determines that the aspect ratio of the first sub-frame window 12 is different from the aspect ratio of the first input sub-frame 22′ by the step S11, the first input sub-frame 22″ has to be horizontally scaled by the horizontal proportion and vertically scaled by the vertical proportion which is the same as the horizontal proportion in order to prevent the image displayed on the first sub-frame window 12 from deformation, and the scaled image has to be fit with the horizontal or vertical dimension of the first sub-frame window 12. To do this, the display has to calculate the horizontal proportion and the vertical proportion of the first sub-frame window 12 to the first input sub-frame 22″ (step S13), to determine relation between the horizontal proportion and the vertical proportion (S14), and to select the small one for the next procedure.

In this embodiment, the horizontal proportion of the first sub-frame window 12 to the first input sub-frame 22″ is 0.4463 (=640/1434), the vertical proportion of the first sub-frame window 12 to the first input sub-frame 22″ is 0.6 (=360/600), and therefore, the horizontal proportion (0.4463) is smaller than the vertical proportion (0.6). The display selects the horizontal proportion (0.4463) to scale the first input sub-frame 22″ at the horizontal direction and the vertical direction to generate the second input sub-frame 32′″ (step S18), which means the first input sub-frame 22″ is horizontally and vertically scaled by the horizontal proportion (0.4463) to generate the second input sub-frame 32′″ that has 640×268 pixels. Meanwhile, the first sub-frame window 12 shows the second input sub-frame 32′″ and the black bars located on the upper and lower sides of the second input sub-frame 32′″ if the second input sub-frame 32′″ is directly displayed on the first sub-frame window 12. Thus, the display does not directly display the second input sub-frame 32″' on the first sub-frame window 12. The display adjusts or reduces the vertical dimension of the first sub-frame window 12 to be the same as the second input sub-frame 32″' to generate the second sub-frame window 12″ (step S19). Then, the second sub-frame window 12″ is moved to the edge of the screen 11, and the second input sub-frame 32″' displayed on the second sub-frame window 12″ does not have drawbacks of the deformation and the black bars.

In conclusion, the present invention can dynamically adjust dimensions of the first sub-frame window according to the aspect ratio of the first input sub-frame, so that the first input sub-frame displayed on the adjusted second sub-frame window in the full window manner does not have drawbacks of the deformation and the black bars.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method applied to a display for displaying a sub-frame, the method comprising:
calculating a horizontal proportion and a vertical proportion of a first sub-frame window to a first input sub-frame when the display determines that an aspect ratio of the first sub-frame window is different from an aspect ratio of the first input sub-frame;
horizontally scaling the first input sub-frame by the vertical proportion and vertically scaling the first input sub-frame by the vertical proportion to generate a second input sub-frame when the horizontal proportion is greater than the vertical proportion, adjusting a horizontal dimension of the first sub-frame window to be the same as the second input sub-frame to generate a second sub-frame window, and displaying the second input sub-frame on the second sub-frame window; and
horizontally scaling the first input sub-frame by the horizontal proportion and vertically scaling the first input sub-frame by the horizontal proportion to generate the second input sub-frame when the horizontal proportion is smaller than the vertical proportion, adjusting a vertical dimension of the first sub-frame window to be the same as the second input sub-frame to generate the second sub-frame window, and displaying the second input sub-frame on the second sub-frame window.

2. The method of claim 1, further comprising:
displaying the first input sub-frame on the first sub-frame window in a full window manner when the display determines that the aspect ratio of the first sub-frame window is identical with the aspect ratio of the first input sub-frame.

3. The method of claim 1, further comprising:
moving the second sub-frame window to an edge of a screen of the display.

4. The method of claim 1, wherein the method is applied to the display with picture-in-picture function.
